(19) United States
(12) Patent Application Publication
(10) Pub. No.: US 2004/0203662 A1
(43) Pub. Date: Oct. 14, 2004

(54) Systems and methods for facilitating printing from a telephone

(76) Inventor: John Leland Boldon, Emmett, ID (US)

Correspondence Address: HEWLETT-PACKARD COMPANY, Intellectual Property Administration, P.O. Box 272400, Fort Collins, CO, 80527-2400, US

(21) Appl. No.: 10/342,560

(22) Filed: Jan. 15, 2003

(51) Int. Cl. H04M 3/42; H04Q 7/20

(52) U.S. Cl. 455/414.1; 455/445

(57) ABSTRACT

Disclosed are systems and methods for facilitating printing from a telephone. In one embodiment, a system and method pertains to receiving selection of data stored on the telephone to be printed, initiating a data call with an imaging device so as to establish a connection with the imaging device, and facilitating transmission of the selected data to the imaging device for printing. In another embodiment, a system and method pertains to receiving print data transmitted from the telephone, receiving printing selections entered by a user, and facilitating printing of the received print data in accordance with the received printing selections.

### BACKGROUND

With the recent appearance of mobile telephones having computing capabilities, persons now may receive and carry data with them in their mobile telephones as they travel from place to place. For instance, such telephones may now receive email messages. Despite the computing capabilities of such telephones, data stored on the telephones typically can only be printed by downloading the data to a computer, such as the user's personal computer (PC), and then transmitting the data from the computer to an imaging device such as a printer.

Problems arise, however, when such an individual wishes to print a hardcopy of data stored on the telephone, but is away from his or her computer. In particular, the user must normally somehow transmit the data to a local computer that is capable of printing to a local printing device. This normally is not possible, however, unless the computer is already configured to receive the data from the telephone. Unfortunately, this typically is not the case given that the software and/or hardware required for this purpose is not in common use.

### SUMMARY

Disclosed are systems and methods for facilitating printing from a telephone. In one embodiment, a system and method pertains to receiving selection of data stored on the telephone to be printed, initiating a data call with an imaging device so as to establish a connection with the imaging device, and facilitating transmission of the selected data to the imaging device for printing.

In another embodiment, a system and method pertains to receiving print data transmitted from the telephone, receiving printing selections entered by a user, and facilitating printing of the received print data in accordance with the received printing selections.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system through which printing from a telephone is facilitated.

FIG. 2 is a block diagram of an embodiment of a telephone shown in FIG. 1.

FIG. 3 is a block diagram of an embodiment of an imaging device shown in FIG. 1.

FIG. 4 is a flow diagram that illustrates an embodiment of operation of the system shown in FIG. 1 in facilitating printing from a telephone.

FIG. 5 is a flow diagram that illustrates a first embodiment of operation of a print manager of the telephone of FIG. 2.

FIG. 6 is a flow diagram that illustrates a first embodiment of operation of a telephone interface manager of the imaging device of FIG. 3.

FIGS. 7A and 7B provide a flow diagram that illustrates a second embodiment of operation of the telephone interface manager of the imaging device of FIG. 3.

FIG. 8 is a flow diagram that illustrates a second embodiment of operation of the print manager of the telephone of FIG. 2.

FIG. 9 is a schematic view of a portion of the telephone of FIG. 2, illustrating an embodiment of a screen of an interface imported from an imaging device.

### DETAILED DESCRIPTION

As identified above, printing from a telephone, such as a mobile telephone, to an imaging device can be problematic. Disclosed herein are systems and methods that facilitate such printing. In the following discussion, specific systems and methods are described. These systems and methods are mere embodiments, however, that are provided for purposes of example in explaining the manner in which printing from a telephone may be facilitated. Accordingly, many alternatives are feasible. For instance, although “printing” is specifically discussed, other imaging device functionalities can be accessed including, for example, faxing and digital sending.

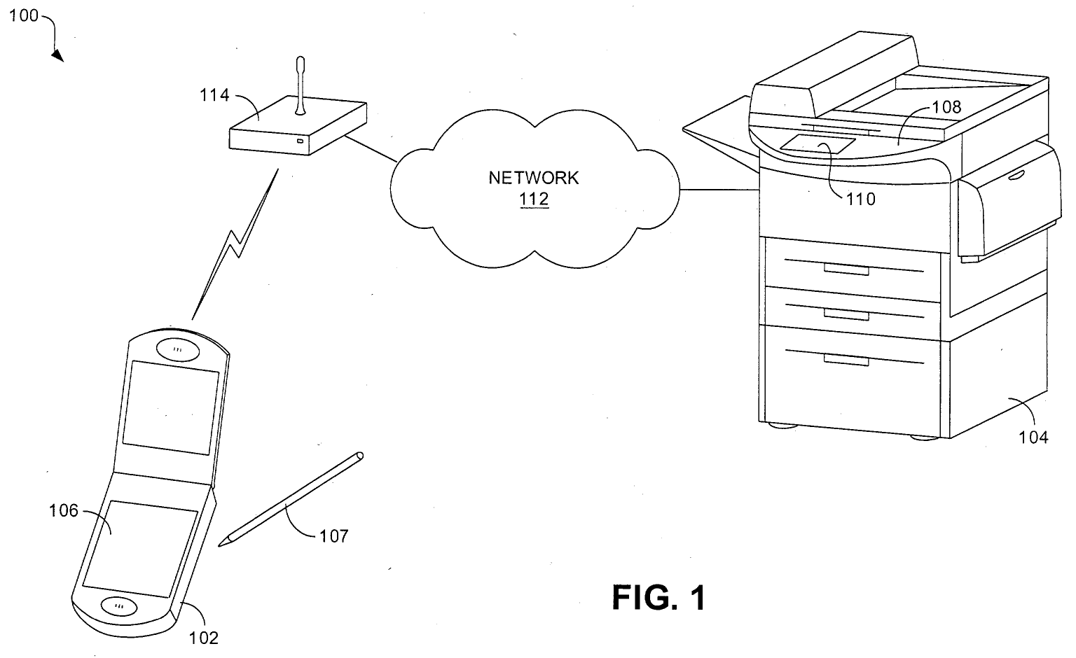

Referring now in more detail to the figures in which like numerals identify corresponding parts, FIG. 1 illustrates an example system 100 in which printing from a telephone can be facilitated. As indicated in this figure, the system 100 generally comprises a telephone 102 and an imaging device 104. As indicated in FIG. 1, the telephone 102 can, for instance, comprise mobile telephone. More particularly, the telephone 102 may comprise a mobile telephone incorporating one or more functionalities of a personal digital assistant (PDA), in which case the telephone may be considered a hybrid device. Regardless, the telephone 102 typically comprises a display 106 with which information may be communicated to the user and, optionally, with which the user may enter commands and selections with the telephone (e.g., in the case where the display is a touch-sensitive screen). Where the display 106 is touch-sensitive, a stylus 107 may be used to enter the commands and selections.

As illustrated in FIG. 1, the imaging device 104 may comprise a printer. More generally, however, the imaging device 104 comprises substantially any device that is capable of receiving data and generating a hardcopy output pertaining to the received data. Accordingly, the imaging device could alternatively comprise, for example, a photocopier, a multifunction peripheral (MFP) device, an all-in-one device, a facsimile device, etc. The imaging device 104 includes a control panel 108 that comprises a display 110.

The system 100 may further comprise a network 112 through which the telephone 102 and the imaging device 104 can communicate. Where provided, the network 112 typically comprises one or more sub-networks that are communicatively coupled to each other. By way of example, these networks can include one or more local area networks (LANs) and/or wide area networks (WANs). In some embodiments, the network 112 may comprise a set of networks that forms part of the Internet.

In addition, the system 100 may comprise a system transceiver 114, which may form part of a private branch exchange (PBX), that is capable receiving transmissions from the telephone 102 and routing them to the imaging device 104 via the network 112. In some embodiments, the system transceiver 114 is further used to receive transmissions from the imaging device 104 via the network 112 and transmit them to the telephone 102.

It is noted that although a network 112 and a system transceiver 114 are shown in FIG. 1 and described herein, these components may not be necessary where the imaging device 104 is equipped with its own transceiver and therefore is capable of receiving data “calls” directly from the telephone 102.

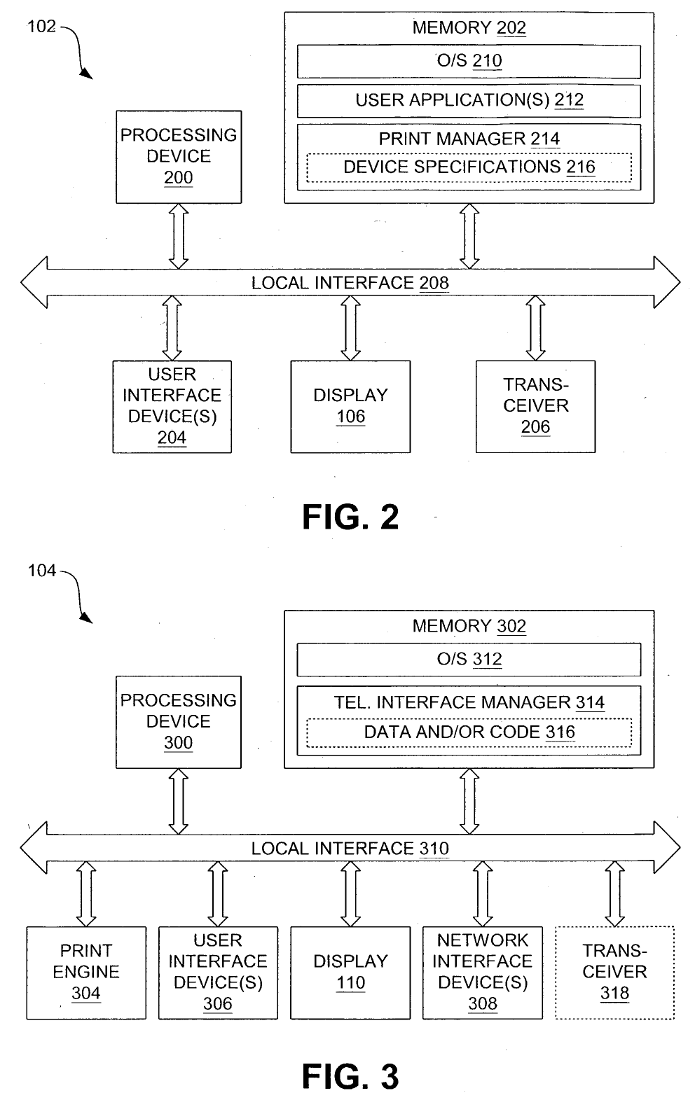

FIG. 2 is a block diagram illustrating an example architecture for the telephone 102 shown in FIG. 1. As indicated in FIG. 2, the telephone 102 comprises a processing device 200, memory 202, user interface devices 204, the display 106 (FIG. 1), and a transceiver 206, each of which is connected to a local interface 208. The processing device 200 can include any custom made or commercially available processor, a central processing unit (CPU) or an auxiliary processor among several processors associated with the telephone 102, a semiconductor based microprocessor (in the form of a microchip), or a macroprocessor. The memory 202 can include any one or a combination of volatile memory elements (e.g., random access memory (RAM, such as DRAM, SRAM, etc.)) and nonvolatile memory elements (e.g., Flash, MRAM, ARS memory, etc.).

The user interface devices 204 comprise those components with which the user operates and controls the telephone 102. These interface devices 204 can include one or more buttons or keys provided on the telephone 102. The display 106 typically comprises a liquid crystal display (LCD) and is used to present a graphical user interface (GUI) to the user. In cases in which the display 106 is touch-sensitive, the display may be considered to be a user interface device 204 in that commands may be entered by touching discrete portions of the display.

The transceiver 206 is used to transmit and receive voice information and data.

The transceiver 206 is normally configured for radio frequency (RF) communications between the telephone 102 and another device such as another telephone, the system transceiver 114, or the imaging device 104.

The memory 202 comprises various programs (in software and/or firmware) including an operating system (O/S) 210, one or more user applications 212, and a print manager 214. The O/S 210 controls the execution of other programs and provides scheduling, input-output control, file and data management, memory management, and communication control and related services. The user applications 212 comprise programs that may serve as source applications for print jobs. By way of example, these applications 212 comprise a word processing application, an email application, or the like.

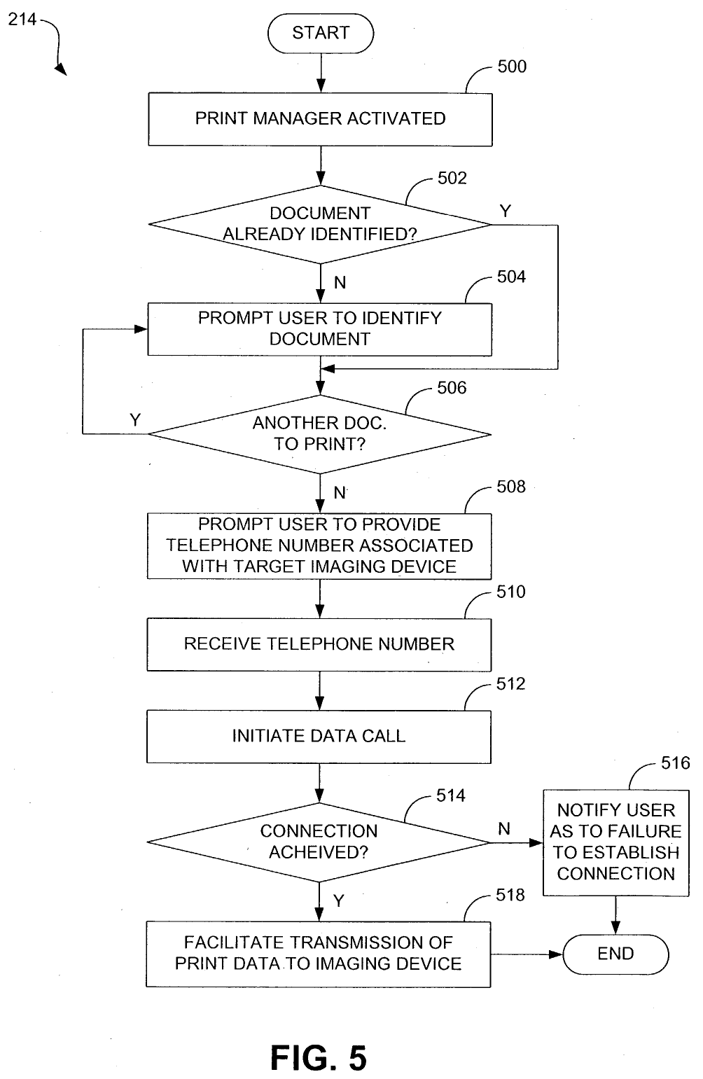

The print manager 214 comprises a program that interacts with a telephone interface manager of the target imaging device. As is described below, the print manager 214 generally facilitates printing from the telephone 102 and may be responsible for responding to requests made by the telephone interface manager of the target imaging device. The print manager 214 may, optionally, comprise device specifications 216 that can be provided to the target imaging device to facilitate the print process. Operation of the print manager 214 is discussed with reference to FIGS. 4, 5, and 8.

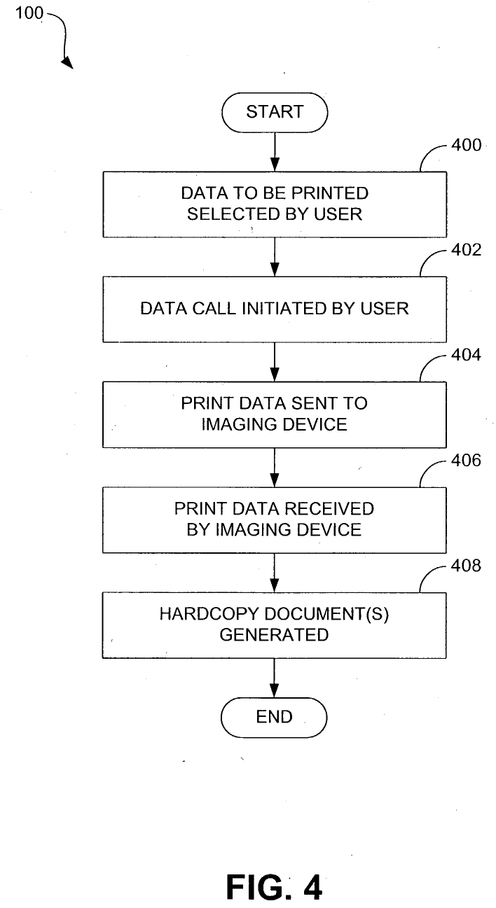

FIG. 3 is a block diagram illustrating an example architecture for the imaging device 104 shown in FIG. 1. As indicated in FIG. 3, the imaging device 104 comprises a processing device 300, memory 302, a print engine 304, user interface devices 306, the display 110 (FIG. 1), one or more network interface devices 308, and, optionally, a transceiver 318. Each of these components is connected to a local interface 310 that, by way of example, comprises one or more internal buses. The processing device 300 is adapted to execute commands stored in memory 302 and can comprise a general-purpose processor, a microprocessor, one or more application-specific integrated circuits (ASICs), a plurality of suitably configured digital logic gates, and other electrical configurations comprised of discrete elements both individually and in various combinations to coordinate the overall operation of the imaging device 104. The memory 302 can include any one or a combination of volatile memory elements (e.g., RAM) and nonvolatile memory elements (e.g., ROM, hard drive, etc.).

The print engine 304 comprises the components with which the imaging device 104 generates hardcopy documents. This engine 304 can comprise the common components of a laser-based imaging device, for instance, a paper drive mechanism, charging member, photosensitive member, optical scanning device, developing member, fusing system, etc. Alternatively, however, the engine 304 can comprise the components of an ink-based imaging device, for instance, a paper driver mechanism, an inkjet, etc.

The user interface devices 306 comprise the interface tools with which the device settings can be changed and through which the user can communicate commands to the imaging device 104. By way of example, the user interface devices 306 comprise one or more keys and/or buttons with which the operation of the imaging device 106 can be controlled. The display 110 typically comprises an LCD and, like display 106 of the telephone 102, may be considered a user interface device 306 if touch-sensitive.

The network interface devices 308 comprise the various components used to transmit and/or receive data over the network 112. By way of example, the network interface devices 308 include a device that can communicate both inputs and outputs, for instance, a modulator/demodulator (e.g., modem), a radio frequency (RF) or IR transceiver, a network card, etc. The transceiver 318, where provided, can have a configuration similar to that of the transceiver 206 of the telephone 102.

The memory 302 includes various programs (in software and/or firmware) including an O/S 312 that contains the various commands used to control the general operation of the imaging device 104. In addition, the memory 302 includes a telephone interface manager 314 that is used to facilitate interfacing with a telephone and, therefore, facilitate printing from a telephone. Optionally, the telephone interface manager 314 may include data and/or code 316 that facilitates the generation and support of an exported interface on the telephone 102. Operation of the telephone interface manager 314 is discussed with respect to FIGS. 4, 6, and 7A-7B.

Various programs have been described above. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussions that follow, flow diagrams are provided. Any process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

As described above, printing from a telephone to an imaging device can be difficult in that downloading to a computer configured to receive data from the telephone is normally first required. With the system 100, however, such downloading is not necessary. An example overview of operation of the system 100 is described in FIG. 4. Beginning with block 400, data to be printed is selected by the telephone user using the telephone user interface devices 204. For instance, a document or documents can be identified using the display 106 and the stylus 107. Once the data has been selected, the user initiates a data call to the imaging device 104, as indicated in block 402. This is accomplished by dialing a telephone number that is associated with the imaging device 104. By way of example, this telephone number can be provided on the imaging device 104 (e.g., on a sticker provided on the control panel 108 or within the imaging device display 110) to facilitate the data call.

Once the data call has been placed, a connection is established and print data is sent to the imaging device 104, as indicated in block 404. This connection can be facilitated by the system transceiver 114 and the network 112, or may comprise a direct connection between the telephone 102 and the imaging device 104 where the imaging device is provided with its own transceiver (e.g., transceiver 318). The print data is received by the imaging device 104, as indicated in block 406, and, as indicated in block 408, so that one or more hardcopy documents can be generated by the imaging device.

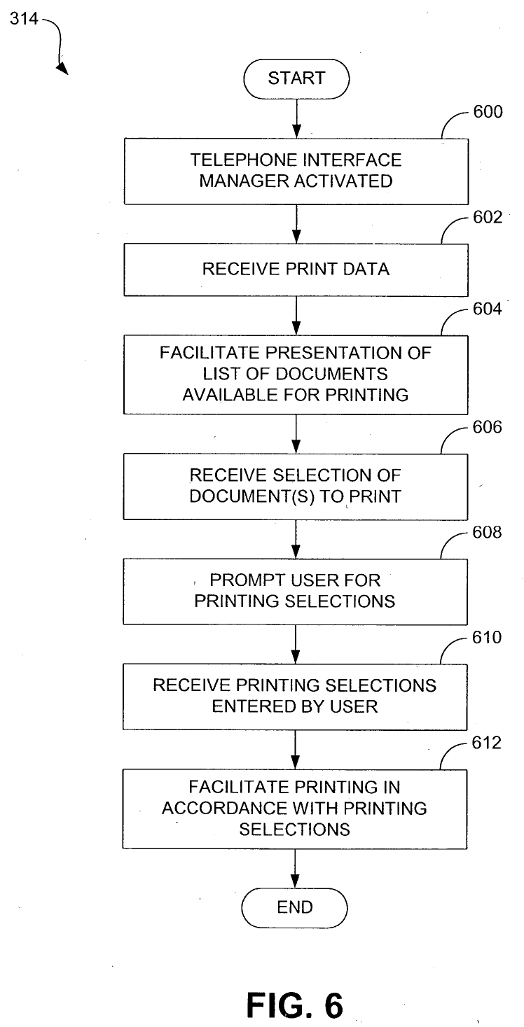

FIG. 5 provides a first example of operation of the print manager 214 of the telephone 102 in facilitating printing. Beginning with block 500, the print manager 214 is activated. This activation can, for example, occur in response to a “print” command being selected on the telephone 102. For instance, such a print command can be selected while viewing a document the user wishes to print that is presented in a user application 212 (e.g., email application) executed by the telephone 102. Alternatively, a print command can be selected from a separate user application 212 associated with the print manager 214. With reference to decision block 502, it can then be determined whether a document has already been identified for printing. If so, for instance where the print command was received while a given document is presented to the user in the display 106, flow continues down to decision block 506 described below. If, on the other hand, no such document has been identified, flow continues to block 504 at which the print manager 214 prompts the user to identify a document to be printed.

Once a document has been identified in block 504, or if a document had already been identified (decision block 502), it is determined whether another document is to be printed, as indicated in decision block 506. If so, flow returns to block 504 and the user is prompted to identify this document. If not, however, all documents to be printed have been identified and, as indicated in block 508, the print manager 214 prompts the user to provide the telephone number associated with the target imaging device 104. The user may then enter this number using the interface devices 204 of the telephone 102, and the telephone number is received by the print manager 214, as indicated in block 510.

At this point, the print manager 214 initiates the data call to the imaging device 104, as indicated in block 512. With reference to decision block 514, if a connection is not achieved (for instance after one or multiple attempts), flow continues to block 516 at which the user is notified that a connection cannot be established. For instance, an appropriate message can be conveyed to the user with the display 106. Assuming a connection is established, however, flow continues to block 518 and the print manager 214 facilitates transmission of the print data to the imaging device 104.

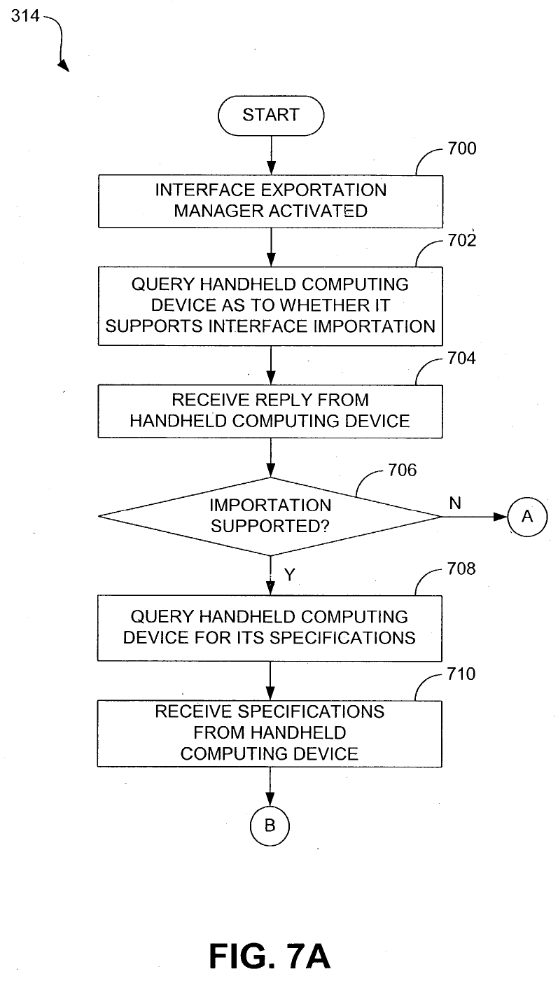

FIG. 6 provides an example of operation of the telephone interface manager 314 of the imaging device 104 in a situation in which print data is transmitted to the imaging device in the manner described above with reference to FIG. 5. More specifically, FIG. 6 provides an example of operation of the telephone interface manager 314 when the print data has been transmitted in the manner described in FIG. 5 by a user that is proximate to the imaging device 104 and therefore able to enter selections with the imaging device directly.

Beginning with block 600 of FIG. 6, the telephone interface manager 314 is activated. This activation can occur, for example, once a connection is established between the telephone 102 and the imaging device 104. Once so activated, the telephone interface manager 314 receives the print data sent by the telephone 102, as indicated in block 602. After this print data is received, the telephone interface manager 314 facilitates presentation of a list of the data (e.g., documents) that are available for printing, as indicated in block 604. Typically, this list is presented to the user in the control panel display 110 of the imaging device 104 and comprises a listing of the titles of the documents that have been sent to the imaging device 104 from the telephone 102. At this point, the user can select documents from the list to be printed, as indicated in block 604. This step not only provides verification as to which documents are to be printed, but also facilitates identification of printing selections as to each identified document individually, if desired.

With reference to block 606, the document selections are received. At this point, the telephone interface manager 314 prompts the user for the printing selections that pertain to the selected documents. These printing selections pertain to the various particular capabilities of the imaging device 104. By way of example, these selections can pertain to the media type to be used, the number of copies to be created, document finishing options, single-sided or duplex printing, contrast, scaling, output tray preferences, and the like. Notably, through the document selection process, different printing selections may be made for different documents, if desired. In view of the ability of the user to enter printing selections in this manner, the described method permits the user to take full advantage of the functionalities of the imaging device 104, even though the telephone 102 may lack knowledge of these functionalities.

Referring next to block 610, the printing selections are received and, as indicated in block 612, printing of the document or documents in accordance with the printing selections is facilitated.

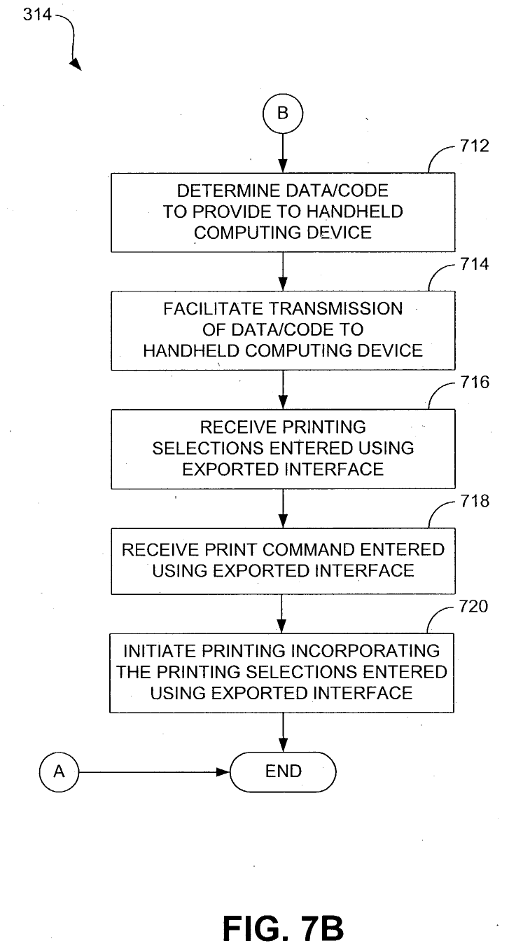

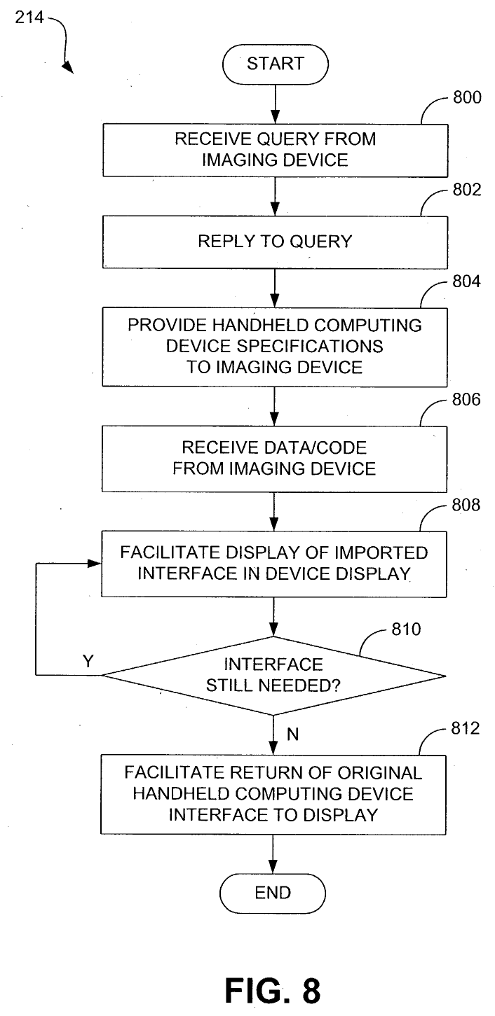

In the printing scenario described with reference to FIG. 6, it is presumed that the user is proximate to the imaging device 104 and therefore capable of entering printing selections directly into the imaging device. Where the user is not proximate to the imaging device 104, alternative operation of the system may be necessary. FIGS. 7 and 8 describe alternative examples of operation of the telephone interface manager 314 of the imaging device 104 and the print manager 214 of the telephone 102, respectively, that may be implemented when the user is not proximate to the imaging device and, therefore, may need to identify printing selections using the telephone.

In this “mode” of operation, an interface is exported from the imaging device 104 and imported by the telephone 102. The exported/imported interface presents the user with various printing options that the user may select from the telephone 102, and which may then be transmitted back to the imaging device 104. Although this “mode” of operation is described in the context of a remote user, such operation could, optionally, be used even when the user is proximate to the imaging device 104, if desired. In some embodiments, the mode of operation used may be automatically selected depending upon the user's proximity with the imaging device 104. For instance, the user can be prompted to identify whether the imaging device 104 is or is not currently accessible to the user and operation dictated by the user's response.

With reference to block 700 of FIG. 7A, the telephone interface manager 314 is activated. This activation typically occurs automatically upon the establishment of a communication link between the imaging device 104 and a telephone 102. Once activated, the telephone interface manager 314 queries the telephone 102 as to whether it supports interface importation, as indicated in block 702. In particular, the telephone interface manager 314 queries the telephone 102 as to whether it can follow a protocol in which the interface normally presented on the telephone display 106 can be replaced with an interface that pertains to the imaging device 104 such that the telephone display is used as a proxy display by the imaging device.

After the query has been sent, a reply is received, as indicated in block 704. From this reply, it can be determined, in decision block 706, whether interface importation is or is not supported. If not, exportation of the interface is not feasible and flow for the session is terminated (FIG. 7B). If, on the other hand, interface importation is supported by the telephone 102, flow continues to block 708 at which the telephone interface manager 314 queries the telephone for its specifications. These specifications generally pertain to the capabilities of the telephone 102 that affect the manner in which the imported interface can be hosted, and may specifically pertain to the size of the telephone display 106, whether color images can be presented in the display, whether the telephone is capable of executing a received executable program, etc.

After the telephone specifications are received, as indicated in block 710, flow continues to block 712 of FIG. 7B at which the telephone interface manager 314 determines what to send to the telephone 102 to enable it to support the interface. In particular, the telephone interface manager 314 determines what data and/or code 316 to provide to the telephone 102 to facilitate its support of the interface. In terms of data, transmitted may be descriptions of various features (e.g., buttons) to be presented (including text, graphics, and images) in the telephone display 106, their placement within the display, and the colors of the various features (where color is supported by the telephone).

Code that supports these features may include any code necessary to recognize selection of a feature (e.g., button) and register it so that it is communicated back to the imaging device 104. In one arrangement, this code is configured to facilitate immediate communication of the selection back to the imaging device 104. In another arrangement, all various selections may be noted and retained so that all selections are transmitted to the imaging device 104 at substantially the same time (e.g., when a “print” or “send” command is selected). By way of example, this functionality can be provided by an executable program (e.g., Applet) sent to the telephone 102 that is configured to generate the interface and monitor its use. Although such code may be provided to the telephone 102, such code may, alternatively, already exist on the telephone. In such a case, transmission of data alone to the telephone 102 may be sufficient.

Next, with reference to block 714, the telephone interface manager 314 facilitates transmission of the data/code 316 to the telephone 102. Once any printing selections have been entered by the user using the interface provided in the telephone display 106, the telephone interface manager 314 can then receive the printing selections, as indicated in block 716, as well as a print command, as indicated in block 718. At this point, the telephone interface manager 314 can initiate printing of one or more hardcopy documents incorporating the various printing selections entered by the user via the imported interface, as indicated in block 720. Notably, feedback can be provided to the user via the imported interface of the telephone 102 during printing. For instance, the user can be notified of the printing process with a “printing_of 20 pages” message. The data for such a message can be transmitted to the telephone 102 from the imaging device 104 during printing.

FIG. 8 illustrates an example of operation of the print manager 214 of the telephone 102. Beginning with block 800, the print manager 214 may be activated upon receiving a query from the imaging device 104 and, more particularly, from the telephone interface manager 314 of the imaging device. As noted above, this query may pertain to whether the telephone 102 supports interface importation. In addition, the query may pertain to the specifications of the telephone 102. Once the query or queries are received, the print manager 214 replies, as indicated in block 802. This reply may comprise providing the telephone specifications to the imaging device 104, as indicated in block 804.

Next, the data and/or code necessary to generate and support the interface on the telephone 102 is received, as indicated in block 806. At this point, the print manager 214 has the information and/or code it needs to facilitate presentation of an imaging device-specific interface to the user. This interface can be presented immediately in the telephone display 106, or can be presented after the user has identified a document to be printed. In the latter case, the user can select a document for printing (if one had not already been identified) using the telephone user interface devices 204.

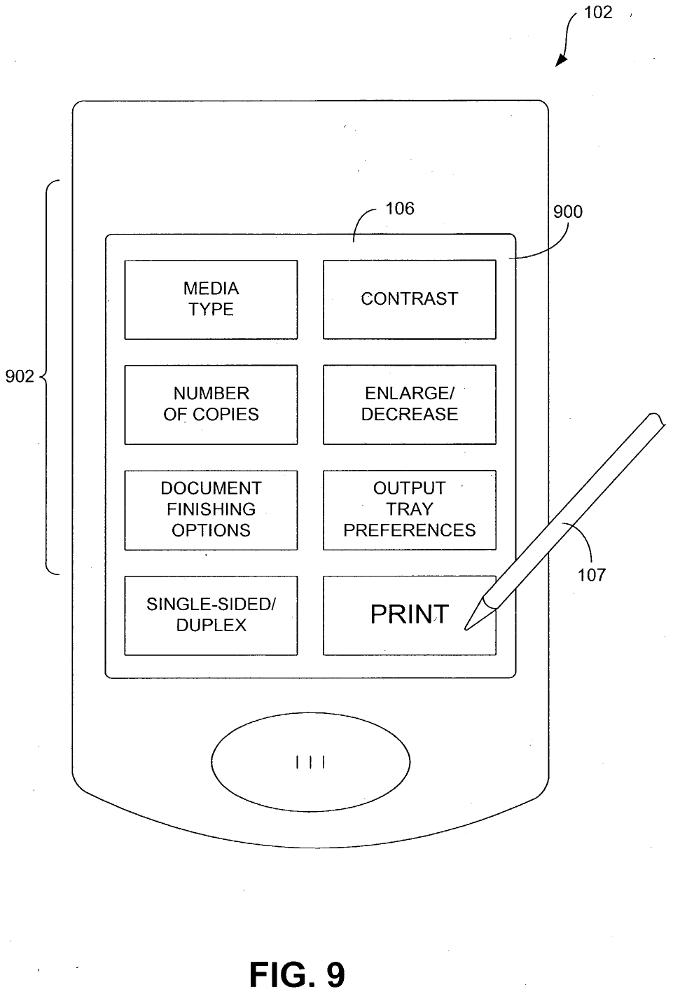

After identifying a document that is to be printed, or upon receiving all data and/or code needed to generate the interface, the print manager 214 facilitates display of the imported interface, as indicated in block 808. This interface is specific to the imaging device 104 and therefore provides access to particular functionalities that the imaging device possesses. An example screen of such an interface is depicted in FIG. 9. As shown in this figure, the imported interface screen 900 comprises a plurality of features in the form of selectable, on-screen “buttons” 902. As indicated in the example of FIG. 9, the particular interface screen 900 includes buttons 902 associated with selecting the media type, the number of copies to be created, document finishing options, single-sided or duplex printing, contrast, scaling, and output tray preferences. Although these particular options or functionalities have been identified, it is to be understood that they are merely exemplary in nature. Each button 902 may be associated with one or more other interface screens (not shown) such that a drill-down menu is provided. For example, the “document finishing options” button may be associated with an interface screen that pertains to folding and stapling options. By selecting this button (e.g., by tapping on it with the stylus 107), this other screen may be accessed.

With reference back to FIG. 8, it is determined in decision block 810 whether the imported interface is still needed. In other words, it is determined whether the printing session is done. Termination of the printing session can be indicated by the user by, for instance, selecting a “disconnect” button provided in one of the interface screens (not shown), or by simply breaking the communication link that had been established between the imaging device 104 and the telephone 102 by ending the data call. In either case, flow continues to block 812 at which the print manager 214 facilitates the return of the original telephone interface to the device display 106. This may comprise marking all data and/or code received from the imaging device 104 for deletion. Alternatively, however, the data/code may be stored for later use in memory 202, if desired.

What is claimed is:

1. A method for facilitating printing from a telephone, comprising:
receiving selection of data stored on the telephone to be printed;
initiating a data call with an imaging device so as to establish a connection with the imaging device; and
facilitating transmission of the selected data to the imaging device for printing.

2. The method of claim 1, wherein receiving selection of data comprises receiving selection entered using a display of the telephone of a document to be printed.

3. The method of claim 1, wherein initiating a data call comprises facilitating dialing of a telephone number associated with the imaging device.

4. The method of claim 1, wherein facilitating transmission of the selected data comprises facilitating transmission of the selected data to a transceiver that is connected to a network that is, in turn, connected to the imaging device such that the data is transmitted to the imaging device via a network.

5. The method of claim 1, wherein facilitating transmission of the selected data comprises facilitating transmission of the selected data directly to a transceiver of the imaging device.

6. A method for facilitating printing from a telephone, comprising:
receiving print data transmitted from the telephone;
receiving printing selections entered by a user; and
facilitating printing of the received print data in accordance with the received printing selections.

7. The method of claim 6, wherein receiving print data comprises receiving print data via a network to which the print data was transmitted from the telephone.

8. The method of claim 6, wherein receiving print data comprises receiving print data directly from the telephone using an imaging device transceiver.

9. The method of claim 6, wherein receiving printing selections comprises receiving printing selections entered using an imaging device control panel.

10. The method of claim 6, wherein receiving printing selections comprises receiving printing selections entered using an imaging device control panel display.

11. The method of claim 6, further comprising prompting the user to select a document to print using an imaging device control panel display prior to receiving printing selections from the user.

12. A method for facilitating printing from a telephone, comprising:
exporting an imaging device-specific interface to the telephone;
receiving printing selections entered by a user using the exported interface; and
facilitating printing in accordance with the printing selections.

13. The method of claim 12, wherein exporting an imaging device-specific interface comprises facilitating transmission to the telephone of data pertinent to generating the interface on a display of the telephone.

14. The method of claim 12, wherein exporting an imaging device-specific interface comprises facilitating transmission to the computing device of code used to recognize selection of a feature presented in the interface.

15. The method of claim 12, wherein receiving printing selections comprises receiving selections entered with the exported interface on a display of the telephone and transmitted by the telephone.

16. The method of claim 12, further comprising receiving specifications regarding the telephone prior to exporting an imaging device-specific interface, and determining what data or code to be transmitted to the telephone in view of the received specifications.

17. A method for facilitating printing from a telephone, comprising:
importing an imaging device-specific interface from an imaging device;
receiving printing selections entered by a user using the imported interface; and
facilitating printing in accordance with the printing selections.

18. The method of claim 17, wherein importing an imaging device-specific interface comprises receiving from the imaging device data pertinent to generating the interface on a display of the telephone.

19. The method of claim 17, wherein importing an imaging device-specific interface comprises receiving from the imaging device code used to recognize selection of a feature presented in the interface.

20. The method of claim 17, wherein facilitating printing comprises facilitating transmission of the received selections to the imaging device.

21. The method of claim 17, further comprising facilitating transmission of specifications regarding the telephone to the imaging device prior to importing an imaging device-specific interface.

22. A print manager stored on a computer-readable medium, comprising:
logic configured to identify data stored on the telephone to be printed;
logic configured to initiate a data call to a target imaging device; and
logic configured to facilitate transmission of the selected data to the imaging device for printing.

23. The manager of claim 22, wherein the logic configured to facilitate transmission comprises logic configured to facilitate transmission of the selected data to a transceiver that is connected to a network to which the imaging device is connected.

24. The manager of claim 22, wherein the logic configured to facilitate transmission comprises logic configured to facilitate transmission of the selected data directly to a transceiver of the imaging device.

25. A telephone interface manager stored on a computer-readable medium, comprising:
logic configured to receive print data that has been transmitted from the telephone;
logic configured to recognize entry of printing selections of a user; and
logic configured to facilitate printing of the received print data in accordance with the received printing selections.

26. The manager of claim 25, wherein the logic configured to receive print data comprises logic configured to receive print data sent over a network.

27. The manager of claim 25, wherein the logic configured to receive print data comprises logic configured to receive print data directly from the telephone through a data call to an imaging device transceiver.

28. A telephone interface manager stored on a computer-readable medium, comprising:
logic configured to facilitate transmission of an imaging device-specific interface to a telephone so that the interface can be displayed in a display of the telephone;
logic configured to receive printing selections entered by a user using the interface; and
logic configured to facilitate printing in accordance with the printing selections.

29. The manager of claim 28, wherein the logic configured to facilitate transmission is configured to facilitate transmission of data pertinent to generating the interface on the telephone display.

30. The manager of claim 28, wherein the logic configured to facilitate transmission of an imaging device-specific interface is configured to facilitate transmission of code configured to recognize selection of a feature presented in the imported interface.

31. The manager of claim 28, further comprising logic configured to receive specifications regarding the telephone and to determine what data or code to be transmitted to the telephone in view of the received specifications.

32. A telephone interface manager, comprising:
means for transmitting an imaging device-specific interface to a telephone;
means for receiving printing selections entered by a user using the imported interface; and
means for printing a hardcopy document in accordance with the entered printing selections.

33. A print manager stored on a computer-readable medium, comprising:
logic configured to receive an imaging device-specific interface from an imaging device;
logic configured to present the interface in a telephone display;
logic configured to recognize selections of printing options entered by a user using the interface; and
logic configured to facilitate printing in accordance with the printing selections.

34. The manager of claim 33, wherein the logic configured to receive an imaging device-specific interface comprises logic configured to receive and implement data pertinent to generating the interface on the telephone display.

35. The manager of claim 33, wherein the logic configured to receive an imaging device-specific interface comprises logic configured to receive and implement code used to recognize selection of a feature presented in the interface.

36. The manager of claim 33, wherein the logic configured to facilitate printing comprises logic configured to facilitate transmission of the received selections to the imaging device.

37. A print manager, comprising:
means for receiving an imaging device-specific interface from an imaging device, the interface being configured for presentation in a telephone display;
means for recognizing selections of printing options entered by a user using the interface; and
means for transmitting the recognized selections to the imaging device.

38. An imaging device, comprising:
a processing device;
a print engine; and
memory including a telephone interface manager, the manager being configured to facilitate transmission of an imaging device-specific interface to a telephone, to receive printing selections entered by a user using the interface, and to facilitate printing in accordance with the printing selections.

39. A telephone, comprising:
a processing device;
a display; and
memory including a print manager, the manager being configured to receive an imaging device-specific interface from an imaging device that is configured for presentation in the telephone display, to recognize selections of printing options entered by a user using the interface, and to facilitate printing in accordance with the printing selections.
